(19) United States
(12) Patent Application Publication
(10) Pub. No.: US 2002/0185321 A1
(43) Pub. Date: Dec. 12, 2002

(54) Pulley for battery-driven bicycle

(76) Inventor: Kuen-Chyr Lin, Taichung City (TW)

Correspondence Address: DOUGHERTY & TROXELL, SUITE 1404, 5205 LEESBURG PIKE, FALLS CHURCH, VA, 22041, US

(21) Appl. No.: 09/838,115

(22) Filed: Apr. 20, 2001

(51) Int. Cl. B62K 11/00; B62D 61/02; B62M 7/00

(52) U.S. Cl. 180/219

(57) ABSTRACT

This is a structural improvement of pulley for bicycle, involving a pulley gear installed at one side of the joint where a center tube, a bearing and a single-direction flywheel are joined at the center of a rear wheel. Meshed on the pulley gear is a toothed belt. At the other end of the toothed belt is a motor spindle gear. Thereby, a battery providing power to drive the motor, the toothed belt, and the rear wheel to drive the bicycle forward.

### BACKGROUND OF THE INVENTION

1. Field of the Invention

This invention relates to a structure of battery-driven bicycle, with improvement made on the shortcomings of conventional models, or specifically, to a structural improvement of pulley for battery-driven bicycle, which can be conveniently assembled and easily operated to protect the driving motor.

2. Background of the Invention

Conventionally, a regular bicycle is driven by both feet pedaling, which is used normally for physical fitness or recreational purposes. For traveling purposes, a motorcycle may be used instead. But motorcycles could cause air pollution, and waste of natural resources. At the moment, we can see a type of battery-driven bicycle on the market, which serves the purposes of both a motorcycle and a bicycle. Though that structure could improve the above shortcomings, but it involves a drawback in application, that is, when the bicycle is stopped, the driving motor moves continuously. Especially when the bicycle is reversed, the pulley could be driven forcefully to cause overheat and damage to the motor.

In view of the above shortcomings, the inventor has utilized several years experience in the production and sale of related businesses, and after repeated research, development, tests and production, has finally come up with a practical product with effective improvement on conventional shortcomings. This invention will hopefully upgrade our industrial standards, prompt industrial and commercial development, ingest confidence to our people and enhance our national competitiveness.

### BRIEF DESCRIPTION OF THE INVENTION

The main objective of this invention is to provide a structural design of pulley to achieve the purpose of convenient, speedy and smooth assembly, to bring improvement to conventional shortcomings, to provide industrial applicability, and enhance economical benefits.

Therefore, the subject invention of structural improvement of pulley for battery-driven bicycle involves a pulley driving mechanism by installing a belt gear on one side of the joint where a center tube, a bearing and a single-direction flywheel are joined at the center of a rear wheel. Meshed on the belt gear is a toothed belt. At the other end of the toothed belt is a motor spindle gear. Then, a battery is installed to provide power to the driving motor to rotate the toothed belt and the rear wheel, to drive the bicycle forward.

### BRIEF DESCRIPTION OF DRAWINGS

The drawings of preferred embodiments of this invention are described in following details to enable better understanding.

FIG. 1 is an exploded view of the invention.

FIG. 2 is a perspective view of the invention.

FIG. 3 is an embodiment view of the invention.

FIG. 4 is an embodiment view of the invention.

FIG. 5 is an embodiment view of the invention.

BRIEF DESCRIPTION OF NUMERALS

| | |
|---|---|
| 10 | rear wheel |
| 20 | pulley-driving mechanism |
| 21 | center tube |
| 22 | bearing |
| 23 | flywheel |
| 24 | pulley gear |
| 25 | toothed belt |
| 26 | spindle gear |
| 27 | battery |
| 28 | radar |
| 30 | battery-driven bicycle |

### DETAILED DESCRIPTION OF PREFERRED EMBODIMENTS

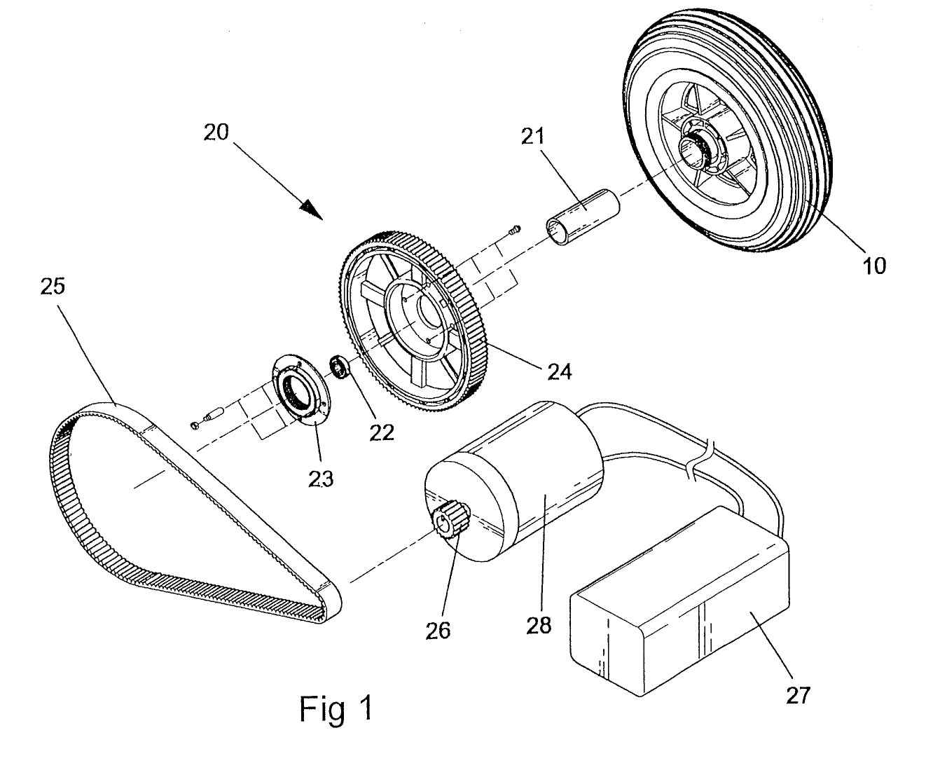

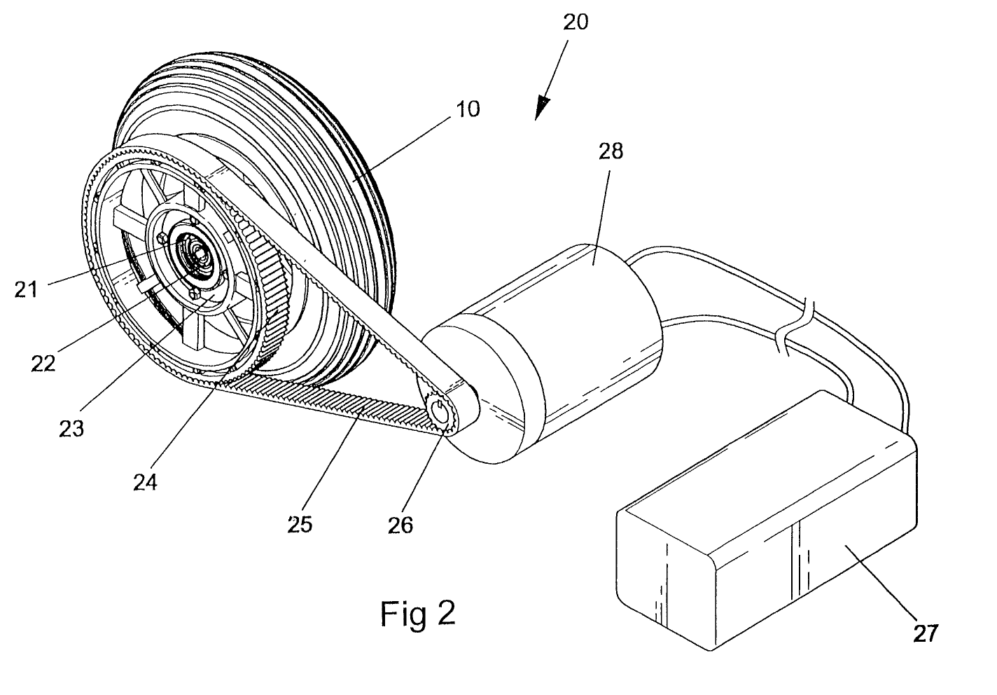

As shown in FIGS. 1 and 2, which illustrate a structural improvement of pulley for battery-driven bicycle, involving a pulley driving mechanism 20 that is installed at an appropriate location on the rear wheel 10 of a battery-driven bicycle (not shown in diagram), characterized in that:

Said pulley-driving mechanism 20 involves a pulley gear 24 that is installed at the side of joint where a center tube 21, a bearing 22 and a single-direction flywheel 23 are joined. Meshed with the pulley gear 24 is a toothed belt 25, on the other end is a motor spindle gear 26. Thereby, a battery 27 provides power to drive a motor 28, which in turn drives the toothed belt 25 to rotate and move the rear wheel 10 and the bicycle to travel forward.

As shown in FIGS. 1 and 2, the subject invention is assembled in a way that, first, the bearing 22 is inserted to the center of the rear wheel 10. A center tube 10 is then inserted by the bearing 22 before it is tightly joined to the single-direction flywheel 23, and to the pulley gear 24. This assembly is then fitted to one side of the rear wheel 10. The toothed belt 25 is wound around the belt gear 24 and the motor spindle gear 26 at the other end. This motor 28 is then connected to the battery 27 to comprise the whole unit of pulley-driving mechanism 20.

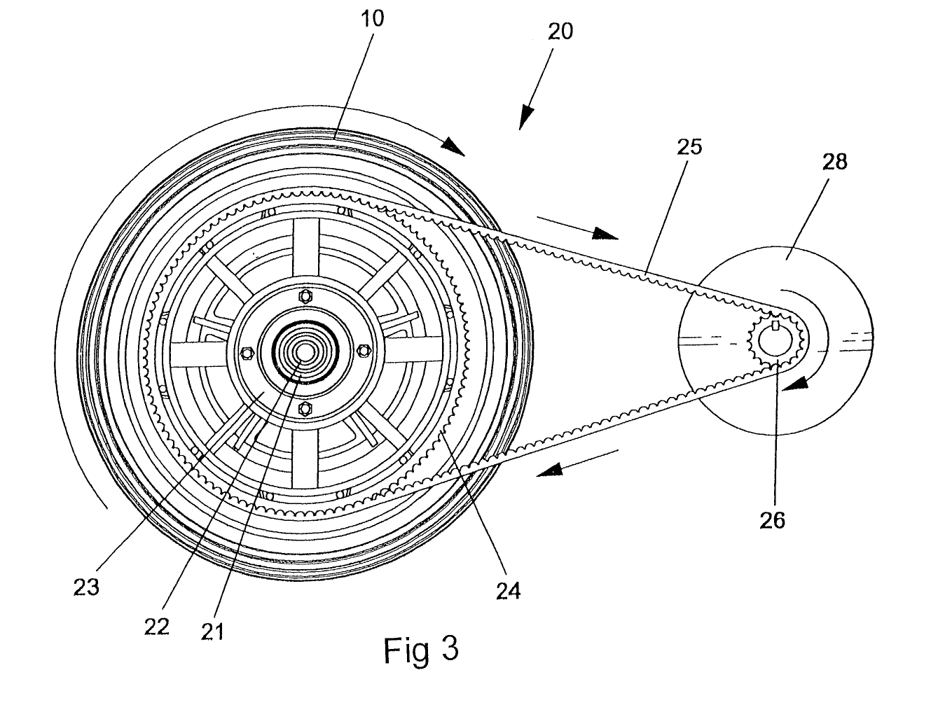

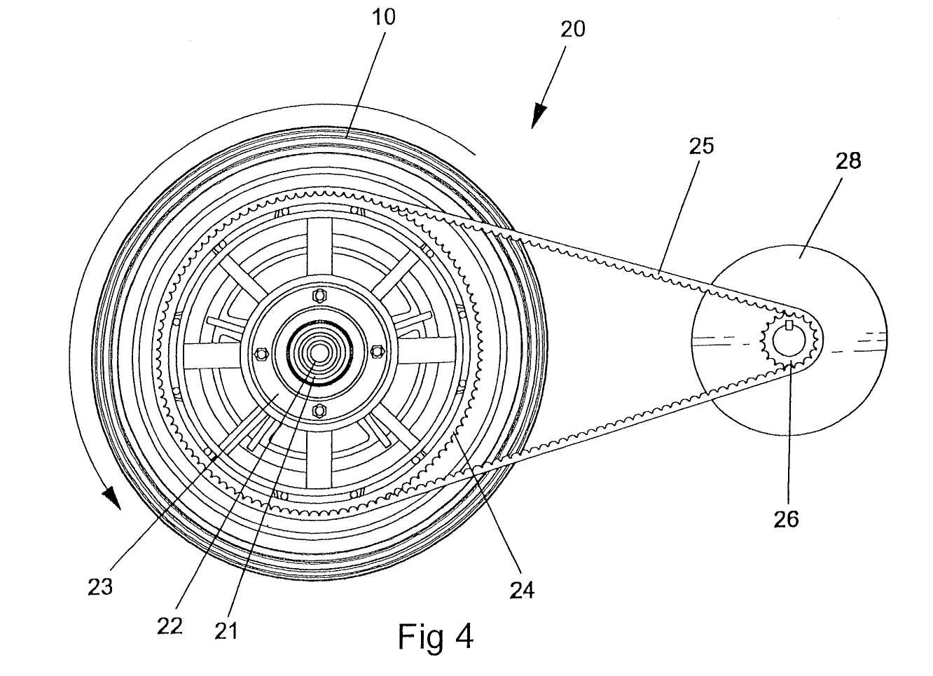

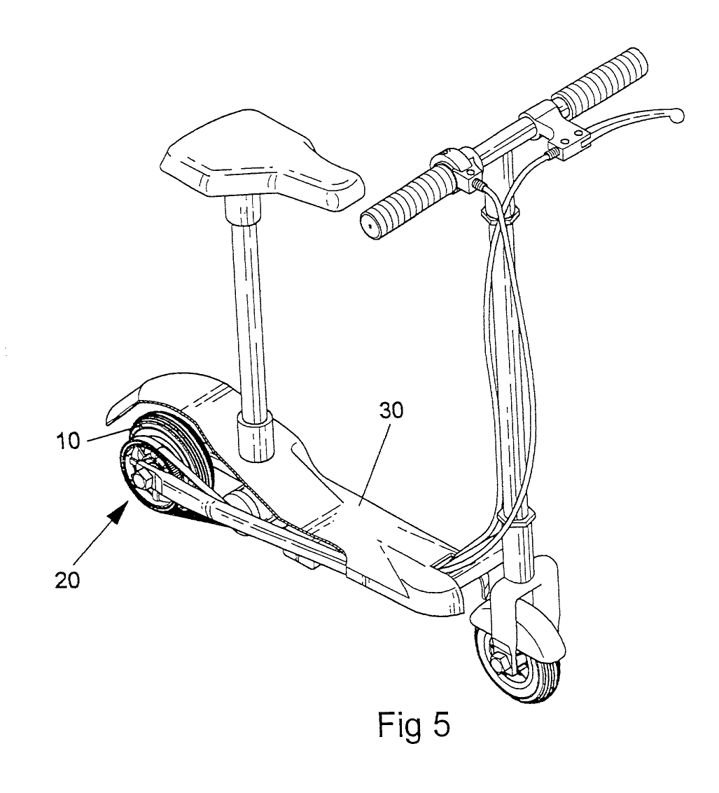

As shown in FIGS. 3, 4 and 5, with reference made to FIGS. 1 and 2, this unit is operated in a way that, first, the cyclist switches on the electric power. So the battery 27 can provide power to the motor 28, driving the motor 28 to rotate. Then the motor spindle gear 26 on the motor 28 will rotate and drive the toothed belt 25 and the belt gear 24. The turning belt gear 24 then drives the rear wheel 10 to move forward, as shown in FIG. 3. When the battery-driven bicycle 30 stops, since the single-direction flywheel 23 turns only in one direction, as shown in FIG. 4, so when the battery-driven bicycle 30 stops, the rear wheel 10 will be running without freely without being engaged to other moving parts. That way, the toothed belt 25 and motor 28 will not be driven continuously to cause overheat and damage to the motor 28, as is often seen in conventional types.

Therefore, the inventor has not only made improvement on the conventional battery-driven bicycle, but also provided better applicability and safety, and integrated practicability and inventiveness.

The features of the subject invention can be categorized as follows:

1. Convenient operation, stable safety.

2. Convenient and speedy assembly.

3. Smooth movement and operational control.

4. Driving components can be maintained to ensure normal operation of components.

What is claimed is:

1. A structural improvement of battery-driven bicycle, involving a pulley driving mechanism that is installed at an appropriate location of the rear wheel of a bicycle, characterized in that:
Said pulley driving mechanism involves a belt gear that is installed on one side of the joint where a center tube, a bearing and a single-direction flywheel are joined at the center of a rear wheel, meshed on the belt gear being a toothed belt, at the other end of said toothed belt being a motor spindle gear, thereby, power is provided by a battery to drive the motor, the toothed belt and the rear wheel, driving the bicycle forward.
